(19) United States
(12) Patent Application Publication
(10) Pub. No.: US 2011/0189352 A1
(43) Pub. Date: Aug. 4, 2011

(54) Convenience Desert Item and Method of Preparation and Use

(76) Inventor: Marietta A. John, Berwick, PA (US)

(21) Appl. No.: 13/020,999

(22) Filed: Feb. 4, 2011

Related U.S. Application Data
(60) Provisional application No. 61/301,250, filed on Feb. 4, 2010.

(51) Int. Cl. A21D 13/08; A23L 3/36

(52) U.S. Cl. 426/94; 426/389; 426/274; 426/89; 426/103

(57) ABSTRACT

A convenience desert item wherein the container is filled with portions of the desert item, which are first prepared outside the container, cut into multiple portions, and placed into the container in layers, each layer is comprised of a plurality of the cut portions, which are gently compressed before placing additional layers on top of said layer, and the final layer having a frosting applied to the top of the final layer; a method of preparing, storing, transporting, and serving a desert item, comprising the steps of preparing a desert, reducing the desert into a plurality of portions, providing a container, said container having a handle, providing a lid adapted to close the container, placing one or more of the portions into the container to create a first layer of portions, compressing the first layer of portions located in the container, placing additional one or more portions into the container to form a second layer of portions, compressing the second layer of portions located in the container, smoothing a top surface of a top layer of portions, placing the lid on the container, freezing the container and/or storing the container, grasping the handle of the container, transporting the container from a first location to a second location while grasping the handle, removing the lid from the container, scooping downwardly into the container, through more than one layer with a utensil to remove a serving portion, placing the serving portion onto a plate, and replacing the lid onto the container.

### CROSS REFERENCE TO RELATED APPLICATIONS

This patent application is a nonprovisional patent application, which claims priority to US provisional patent application No. 61/301,250 filed on Feb. 4, 2010 entitled Convenience Desert Item and Method of Preparation and Use, and incorporates this application by reference as if set forth herein in its entirety.

### BACKGROUND OF THE INVENTION

1. Field of the Invention

The invention generally relates to a convenience desert item, and more particularly, a layered desert that is cut and portioned into a conveniently transportable container having a handle, and a method of preparation, storage and dispensation of said desert.

2. Discussion of Related Prior Art

With convenience being one of the major focuses in the packaged foods industry, product offerings have evolved to meet the convenience of preparation, dispensation, and consumption. Examples include single-serve microwavable soups, coffee pods, prepackaged lunch kits, and single use beverage concentrates. The same allure of convenience applies to desert items such as cakes.

Traditionally, cakes are baked in the home or purchased at a grocer. The cakes typically comprise cake material, filling and frosting, and cakes often are presented on a base such as a plate, a pan, or a cardboard base. Often cakes are purchased in cake boxes at a grocer. Frozen cakes are often purchased at a grocer frozen in boxes in the freezer section.

The traditional cake is often carried from one place to another by holding the underside of the cake support base or the box. The carrier must give particular attention to avoid sudden movements to prevent the cake from being disturbed by coming in contact with the box. Often both hands are used to avoid dropping or disturbing the cake. Thus, when carrying a traditional cake, an individual is occupied from performing other tasks. When transporting a traditional cake in a vehicle, care must be given to avoid shifting of the cake, or to avoid damage from other items coming in contact with the cake. The typical cake is not readily stackable so to avoid damage to the cake.

Serving: The typical cake is served by making a series of transverse cuts into the cake to form edible portions for consumption. The typical portion of cake being layered cake—filling—cake—frosting is often consumed from top to bottom. The consumer often leaves the bottom layer of cake uneaten because said layer contains no filling or frosting.

Storage: After consumption, the remaining portion(s) of the cake are often stored on the counter by covering the cake with cellophane, or aluminum foil. If the cake was purchased in a box, one may retain the cake in the box for storage. The cake also is stored in cellophane, or the box in the refrigerator. Often, the cake goes stale quickly because it is not adequately covered and left on the counter or the refrigerator

The prior art in general and the art discussed do not disclose the inventive product and method disclosed herein—nor does the prior art address the drawbacks discussed above. Therefore, it is desirable to have a desert item and method of production and dispensation that is convenient to prepare, purchase, transport, dispense, consume, and store.

### SUMMARY OF THE INVENTION

The present invention may be embodied as a convenience desert item comprising a container having a handle and a lid. The container is filled with portions of the desert item, which are first prepared outside the container, cut into multiple portions, and placed into the container in layers. Each layer is comprised of a plurality of the cut portions, which are gently compressed before placing additional layers on top of said layer. The final layer having a frosting applied to the top of the final layer.

The present invention may be embodied as a method of preparing, storing, transporting, and serving a desert item, such as cake. The method includes the steps of preparing the desert item, which, in the case of a cake, includes the steps of preparing a cake with filling and frosting. Cake layers are prepared and allowed to cool. Filling is applied to the cake; one or more layers of cake may be applied above the filling. Thereafter frosting is applied. Once the cake is prepared, it is cut into a plurality of portions by cutting through the cake from top to bottom in transverse directions. A container having a handle and a lid is provided. One or more of the cut portions of the desert item or cake is placed into the container to form a first layer. The first layer is gently compressed. One or more subsequent layers of cut portions are placed above the first layer and the subsequent layers and are gently compressed. A top surface is smoothed over the top of the one or more subsequent layers. The lid is then placed on the container. In some instances the desert item is frozen or refrigerated and placed in grocery stores for purchase. The desert item is transported by grasping the handle of the container, and moving the container from a first location to a second location (grocer to home, home to picnic, for example) by grasping the handle of the container.

For serving the desert, the lid is removed from the container, a utensil is provided (preferably an ice cream ladle), the desert is apportioned by scooping downwardly into the container, through more than one layer, and a serving portion is placed onto a plate or other serving ware. The serving process is repeated for additional servings, if necessary. When finished serving, the lid is placed onto the container, and the container is placed in storage by grasping the handle of the container.

### OBJECTS OF THE INVENTION

It is an object of the present invention to present a desert item that is convenient to purchase.

It is another object of the present invention to provide a desert item that is easy to carry.

It is another object of the present invention to provide a desert item that is easy to transport.

It is another object of the present invention to provide a desert item that is easy to store before and after use.

It is another object of the present invention to provide a desert item that is easy to serve from.

It is another object of the present invention to provide a desert item in a container that is capable of being handled with one hand.

It is another object of the present invention to provide a desert item in a container that can be conveniently frozen or refrigerated after part use.

It is another object of the present invention to provide a desert item that is presented for purchase in a one-handed recyclable, carryable container.

It is another object of the present invention to provide a cake that can be picked up and carried with one hand.

It is another object of the present invention to provide a desert item that is servable from a freezer/refrigerator compatible and stackable containment that can be carried with a single hand using a handle.

It is another object of the present invention to provide a desert item and a method of use that presents in one serving an equally distributed mix of its components such that each component flavor is presented in each bite/spoonful taken from the serving.

It is another object of the present invention to present for purchase and consumption a cake that is simple to purchase, transport, store, serve, and store unconsumed portions for later consumption.

It is another object of the present invention to provide a method of producing and packaging a desert item that increases the shelf life of a desert item.

It is another object of the present invention to provide a method of producing and packaging a desert item that allows for sealed frozen/refrigerated storage for later consumption after a partial serving.

It is another object of the present invention to provide a method of producing and packaging a desert item such that said desert item is readily available for serving and reserving, while minimizing preparation time.

It is another object of the present invention to provide a method of producing and packaging, storing and serving a desert item, such as a cake, that maximizes the amount of time the desert item is available for consumption.

### BRIEF DESCRIPTION OF THE DRAWINGS

The advantages, nature and various additional features of the invention will appear more fully upon consideration of the illustrative embodiment of the invention which is schematically set forth in the drawings, in which:

FIG. 1 is a perspective view of the finished cake cut into portions and a container with a first layer of portions.

FIG. 2 is a perspective view showing the step of smoothing frosting of a top layer.

FIG. 3 is a perspective view showing the desert item being grasped with one hand.

### DETAILED DESCRIPTION OF THE DRAWINGS

While the invention is open to various modifications and alternative forms, specific embodiments thereof are shown by way of examples in the drawings and are described herein in detail. There is no intent to limit the invention to the particular forms disclosed.

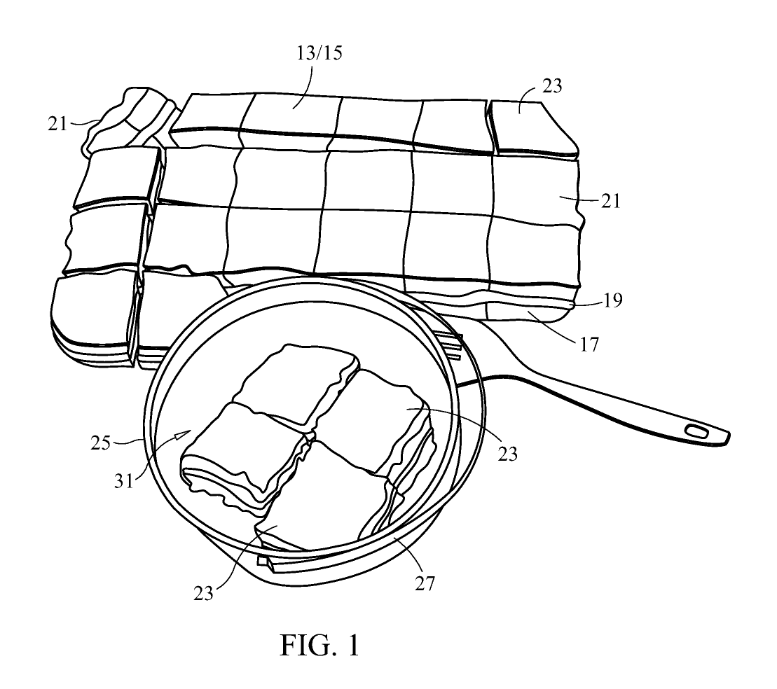

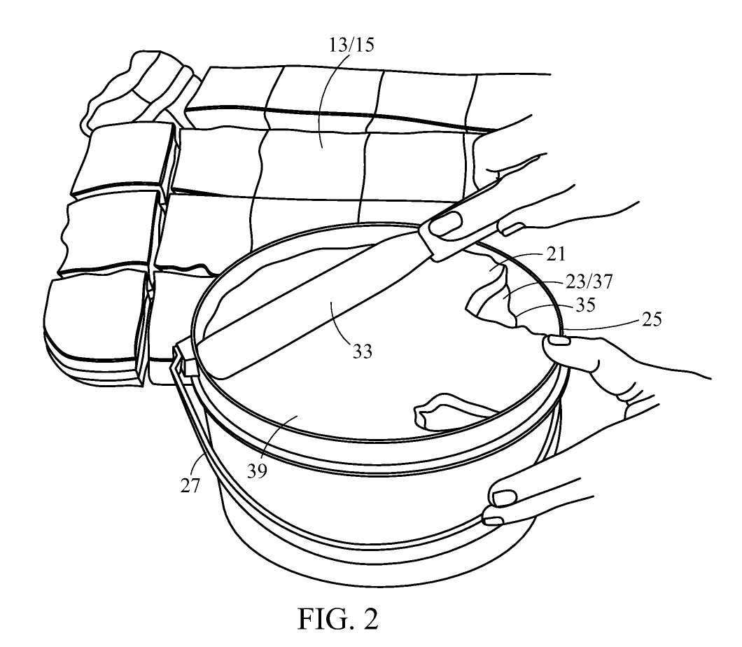

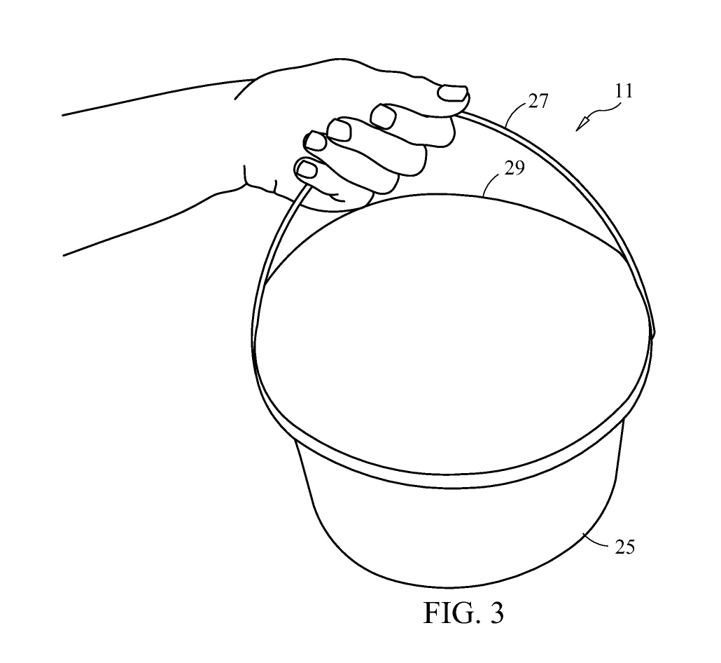

Referring now to the drawings, in particular to FIGS. 1-3, the present invention is a convenience desert item 11 conveniently presenting a desert 13 for consumption. In the preferred embodiment, the desert 13 is a cake 15 of two layers 17 having a filling 19 applied between the two layers 17 and a frosting 21 applied to the cake 15. The desert 13 is cut into multiple portions 23, and placed into a container 25 having a handle 27 and a selectively enclosable member 29.

The desert 13 presented for consumption can be selected from any group of deserts that are prepared in a sheet form and may include various ranging amounts and types of layers, filling, frostings, and cake batters. Similarly, the frostings may vary and description is not intended to limit the desert 13, the cake 15 batter types, the combination of layers 17, the filling variations 19 the number of layers, 17 and the various selectable frosting 21 types.

Once the desert 13 is assembled, or otherwise prepared, the desert 13 is cut into multiple portions 23. The portioning of the two layer cake of the preferred embodiment, for example, is accomplished by making transverse cuts to reduce the two layered cake or desert item 11 into a plurality of portions 23. In automated baking processes, it is understood that other methods are used to comminute the various components of the targeted desert 13 into a mixed texture so to present a fair distribution of each component flavor in each bite for the consumer.

The container 25 preferably is round, but other shapes and variations may be presented as alternate embodiments that are suitable based on the desired presentation. Examples include a rectangular shaped container 25, oval shaped container 25, spherical shaped container 25, and any other suitable shaped container 25 sufficient to hold the desert 13.

The container 25 has a handle 27 connected to said container 25 to enable a user to grasp the container 25 with one hand using the handle 27 to carry the desert 13 contained in the container 25. This allows for convenient transportation serving and storage of the desert 13 contained in the container 25, which is the desert item 11. Preferably, the handle 27 is attached to the container 25 and is pivotal like a pail or bucket configuration. The handle 27 configuration can vary and be included in the selectively enclosable member 29, or lid, based on design choice. All that is necessary is that the handle 27 be capable of allowing a user to transport the desert item 11 containing desert 13 with one hand grasping a handle 27.

The selectively enclosable member 29, preferably is a lid sufficient to allow a user to remove the lid for serving and replace the lid to cover any unconsumed portion of the desert 13. Various selectable enclosable member 29 configurations are available to allow selective sealing of the desert 13 contained in the container 25. This is to allow for containment and storage of the desert item 11 when not in use, for example storage in a freezer or refrigerator.

The preferred embodiment desert 13 is a cake 15 of two layers 17 having a jam or custard layer filling 19 applied between the two layers 17 and a frosting 21 applied to the top of the cake. The desert 13 is cut into multiple portions 23 and placed into the container 25 to form a first layer 31 or first course 31 of cut portions 23. Preferably, the cut portions are placed frosting-side up into the container 25 such that the frosting 21 can be smoothed with a spatula 33, for example, to smooth the frosting 21 of the top of the first layer 31. In mass production, other articles and steps may be used to obtain the same results of the smoothing the frosting 21 of the first layer 31 such may include mechanized or motor controlled blades or other members which contact the top of the first layer 31. Other industrialized methods may include the placement of additional frosting 21 to the top of the first layer 31 and/or other smoothing means.

Subsequent layers 35 of the cut portions 23 are placed upon the first layer 31 and smoothed in accordance with the means discussed herein in reference with the first layer 31. This step repeats itself until a final layer 37 is reached, wherein final layer 37 wherein the frosting 21 at the top of the final layer 37 is smoothed in accordance with the description provided herein. In a preferred embodiment, the frosting or icing also contacts the inside surface(s) of the container where it is sealed to help keep the desert components below fresh.

The first layer 31, subsequent layers 35, and/or final layer 37 are gently compressed using suitable compression means to slightly increase the density of the desert 13 in the container 25. In a preferred embodiment, a plate is used to gently press down on the selected layer 37 or layers 37. The amount of compression applied should not be to a degree such that the desert is not so dense that the desert is capable of being scooped when it immediately removed from the freezer. Sufficient air should remain in the desert so it is scoopable immediately after being removed from the freezer.

Thereafter, the selectively enclosable member 29, a lid, is applied to the top of the container 25 to close the desert 13 into the container 25. The desert 11 is then placed in a freezer or refrigerator for storage. Preferably the desert item 11 is transported to the freezer or refrigerator by grasping the handle 27 connected to the container 25.

My invention further includes a method of preparing, storing, transporting, and serving a desert item 11, such as cake 13. The method comprises the step of preparing the desert 13. Based upon the desert 13 selected, the preparation step will vary and may be based on any traditional known recipe for a cake like desert or pie, or other desert. In a preferred embodiment, with regard to cake 13, the preparation steps include preparing a cake with filling and frosting. This includes baking a cake using batter, allowing the cake to cool, applying a filling to the cake, applying a second layer above the filling, and applying frosting. Thereafter, the cake is cut into a plurality of portions. Preferably, the cake is cut by making transverse cuts into the cake to make portions 23.

A container is then provided 25. Preferably the container is of the type described herein and has a handle 27 and a lid 29 for selectively sealing the desert or cake 13 within the container 25.

One or more of the portions 23 of the desert item 13 are placed into the container 25 to create a layer 31/35/37. In a home kitchen-type setting, this is done manually by grasping the portions 23 or using a spatula. In industrialized or mechanized applications, various configurations may apply sufficient to cause a first layer 31 of portions 23 to be placed into the container 25. Optionally, the first layer 31 may be gently compressed using means sufficient to compress or slightly increase the density of the desert 13. Plunger or piston-type devices are sufficient. In a kitchen application, this is done by gently pressing down on the first layer 31 with a plate fitted within the container. In mechanized and or industrialized applications many means, including those described herein, can be utilized to achieve the same result.

An additional one or more portions 23 are then placed into the container 25 to form a subsequent layer 35. In a preferred embodiment, the desert 13 provided in the first layer 31 is of the same make up or recipe or its components are the same, as the desert 13 of the subsequent layer 35. For flavor variations this may be different in that the desert 13 of one layer may be different from the desert 13 of a subsequent layer 35.

The layer process described herein is repeated until a final layer 37 is reached. An additional compression step may be utilized to slightly increase the density of the desert 13 contained in the container 25. The top surface 39 of the final layer 37 is then smoothed over with a spatula 33. In a preferred embodiment of the invention, smoothing is decoratively applied, for example, by effecting a swirl pattern of the icing or frosting to the top surface 39. As discussed, herein other methods can be utilized to obtain the same result.

A selectively enclosable member 29 is then applied to seal the container 25. This preferably is a top to the container 25. More sophisticated, enclosures, and enclosing steps may be utilized in alternate embodiments, to achieve tamper proofing or providing tamper resistant enclosable members 29. An air space may be provided between the top of the final layer 37 and the selectively enclosable member 29 to allow for expansion.

The convenience desert item 11 and/or its components are put in cold storage such as freezing or refrigerating.

In relation to presenting or marketing the convenience of the desert item 11 at a grocer or other retail establishment, the convenience desert item 11 is presented in frozen or refrigerated food section where it is viewable by prospective purchasers. The convenience desert item 11 is presented in such a way that a consumer, upon deciding to purchase the convenience desert item 11, grasps the handle 27 of the container 25 with one hand and transports the container from a first location to a second location while grasping the handle. This may include moving the convenience desert item 11 from the freezer or refrigerator in the store—to the shopping cart—to the casher point—into a vehicle for transportation to a home—from the vehicle to the home—from a counter into a freezer or a refrigerator.

When ready to serve, the lid 29 is removed from the container 25. A utensil is provided. Preferably, the utensil is an ice cream ladle or similar scoop. A user scoops downwardly into the container 25 into the desert 13 through more than one layer to remove a serving portion. The serving portion is then placed onto a plate. After sufficient serving portions of the desert 13 have been removed from the container 25, the enclosable member 29 is then placed on to the container 25, and the convenience desert item 11 containing the desert 13 is transported back to cold storage, preferably by grasping the handle 27 of the container 25.

The Appendix to this application comprises the provisional application to which the present application claims priority.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

1. A method of preparing, storing, transporting, and serving a desert item, comprising the steps of:
preparing a desert,
reducing the desert into a plurality of portions;
providing a container, said container having a handle;
providing a lid adapted to close the container;
placing one or more of the portions into the container to create a first layer of portions;
compressing the first layer of portions located in the container;
placing additional one or more portions into the container to form a second layer of portions;
compressing the second layer of portions located in the container;
smoothing a top surface of a top layer of portions;
placing the lid on the container;
freezing the container and/or storing the container;
grasping the handle of the container;
transporting the container from a first location to a second location while grasping the handle;
removing the lid from the container;
scooping downwardly into the container, through more than one layer with a utensil to remove a serving portion;
placing the serving portion onto a plate; and
replacing the lid onto the container.

2. The method of claim 1, wherein the step of preparing the desert item includes preparing a cake and cutting the cake into a plurality of portions.

3. The method of claim 2, wherein preparing a cake includes baking cake, allowing the cake to cool, applying filling to a first layer of cake, placing a second layer of cake on top of the first layer, and applying frosting to the second layer of cake.

4. The method of claim 3, wherein the step of reducing the desert into a plurality of portions includes making transverse cuts into the cake from a top surface to a bottom surface.

5. The method of claim 1, wherein the handle of the container is pivotally connected to the container such that the container is capable of swinging relative to the pivot while the handle is carried with a single hand.

6. The method of claim 4, wherein the step of smoothing a top surface of a top layer of portions includes spreading the frosting over the top surface of the top layer.

7. The method of claim 6, wherein the step of compressing the first and/or the second layer of portions is accomplished by pressing down on the layer with a plate, or compressing the layer with a plunger or piston.

8. The method of claim 5, wherein the steps of grasping the handle of the container and transporting the container from a first location to a second location while grasping the handle and transporting the container are performed with a single hand.

9. The method of claim 8, wherein the steps of grasping the handle of the container and transporting the container from a first location to a second location while grasping the handle are performed with a single hand while another hand is occupied performing another task, or otherwise not being used to perform the steps.

10. A convenience desert item for presenting a desert for consumption, comprising:
a plurality of portions of a desert placed in a container to form a first layer of portions,
one or more additional layers of portions of a desert placed in the container above the first layer, and
the first layer of portions, and/or the one or more additional layers of portions being compressed to increase the density of the desert item.

11. The convenience desert item of claim 10, further including a handle attached to or forming part of the container for allowing a user to transport the desert item from a first location to a second location by grasping the handle with one hand.

12. The convenience desert item of claim 11, wherein the handle of the container is pivotally connected to the container such that the container is capable of swinging relative to the pivot while being carried with a single hand.

13. The convenience desert item of claim 12, further including a sealing layer of edible material located at the uppermost level of a top layer of portions of a desert located within the container, and said sealing layer contacts an inside surface of the container.

14. The desert item of claim 13, wherein the sealing layer of edible material comprises icing.

15. The desert item of claim 14, wherein each of the plurality of portions of the desert forming the first layer are cake comprised of a first baked batter course, a course of filling on top of the first course, a second baked batter course on top of the course of filling, and an icing course on top of the second baked batter course.

16. A serving comprising a plate or dish and a scoop of desert item containing portions of a top layer and portions of another layer located below the top layer,
wherein the top layer comprises cake having a first baked batter course, a course of filling on top of the first course, a second baked batter course on top of the course of filling, and an icing course on top of the second baked batter course,
wherein each layer is compressed into a container having a handle attached to or forming part of the container for allowing a user to transport the desert item from a first location to a second location by grasping the handle with one hand while an other hand is not assisting in carrying the container, and
wherein a user inserts a utensil downwardly into the container through the top layer and into another layer located below the top layer to remove the scoop of desert item and place said desert item on the plate or dish.
